(19) United States
(12) Patent Application Publication
(10) Pub. No.: US 2003/0149709 A1
(43) Pub. Date: Aug. 7, 2003

(54) Consolidation of replicated data

(75) Inventor: Andrew D.J. Banks, Hampshire (GB)

Correspondence Address: IBM Corp, IP Law, 11400 Burnett Road, Zip 4054, Austin, TX, 78758, US

(73) Assignee: International Business Machines Corporation, Armonk, NY

(21) Appl. No.: 10/138,893

(22) Filed: May 2, 2002

(30) Foreign Application Priority Data
Feb. 5, 2002 (GB) 0202600.3

(51) Int. Cl. G06F 12/00

(52) U.S. Cl. 707/200

(57) ABSTRACT

Provided are methods, apparatus and computer programs for managing updates to replicated data, which enable one or many replicas of a data resource to be updated independently of a master copy of the data resource, and then each replica to be separately consolidated with the master copy. If data updates applied ‘optimistically’ to a local replica conflict with updates applied to the master copy (since the last consolidation with that replica), then the local updates will not be applied to the master copy. Instead, the conflicting local updates are replaced using the current version of the master copy—preferably by backing out the conflicting update transactions and then applying the latest updates from the master copy. If there are no data conflicts when consolidation is performed, then both the master copy and the replica are successfully updated. This provides the high data availability and scalability of concurrently updatable replicas, while avoiding the complexity of conventional solutions to conflict resolution between replicas. The invention is applicable to on-line goods or services ordering applications, especially where replicas of a data resource are updated on a mobile device.

### FIELD OF INVENTION

The present invention relates to methods, apparatus and computer programs for consolidating updates to replicated data.

### BACKGROUND

It is well known to replicate data to a number of points in a network, to provide the efficiency benefits of local data access from different parts of the network. This provision of multiple copies achieves greater data availability and performance, often with reductions in network traffic, increased resilience to failures and the possibility of workload sharing. This approach is described by Sang Hyuk Son, SIGMOD Record, Vol.17, No.4 (1988).

A number of solutions exist for managing updates to replicated data, but each of the known solutions involves a degree of compromise. Which solution should be used depends on each system's requirements including factors such as data currency, data consistency and system resilience requirements.

Many update strategies for replicated data use a primary copy to which all updates must be performed before being propagated to secondary copies. In some cases the primary copy is fixed, whereas in others the primary update responsibility is transferable. Different proposals are known for broadcasting updates to the secondary copies-immediately, as a batch at the end of transactions, or only at specified intervals-each proposal having associated constraints on factors such as data currency or consistency. A significant focus of research in this area is to address the so called “race conditions” concerning the possibility of a local read taking place before an update has been propagated to the local copy. Such strategies were discussed by C. H. C. Leung and K. Wolfenden in “Analysis and Optimisation of Data Currency and Consistency in Replicated Distributed Databases”, The Computer Journal, Vol. 28, No. 5, 1985, pp.518-523 and by Lindsay et al in “Notes on Distributed Databases”, IBM Research Report RJ2571(33471), IBM Research Laboratory, San Jose, Calif., Jul. 14, 1979, pp. 44-50.

U.S. Pat. No. 5,627,961 discloses replication of data across a distributed system, with updates being performed to a primary copy and then propagated. The reductions in network traffic gained by replication are balanced against the additional network traffic required to update multiple copies of the data by associating a currency period with each copy of a data object. The data object is assumed valid during the currency period. A validity flag is set when it is determined that the currency period has expired, or when updates are applied to the primary copy, and this is checked to determine validity of a copy.

Other update strategies allow ‘optimistic’ concurrent updating of each of the replicas of a data object, and provide various solutions for dealing with any conflicts which arise. Most known conflict resolution solutions are either very complex or rely on manual resolution or both. Many of these solutions assume that the time sequence of updates and high data consistency are critical requirements—seeking to provide all users with a single consistent image of the data if possible.

P. Kumar, “Coping with Conflicts in an Optimistically Replicated File System”, Proceedings of the IEEE Workshop on Management of Replicated Data, November 1990, Houston, Tex., describes conflict resolution in the Coda distributed file system. This allows optimistic updating of replicas, and uses ‘Latest Store IDs’ to detect potentially conflicting updates followed by ‘Coda Version Vectors’ to distinguish between actual conflicts and mere staleness of a replica. When a conflict is identified, further modifications to conflicting replicas are not permitted. According to this 1990 article, a manual repair tool was required to resolve file-update conflicts, although the addition of a file to inconsistent replicas of a directory could be automated.

By 1995, the Coda File System supported transparent resolution of conflicts arising from concurrent updates to a file in different network partitions (such as in mobile environments). This support included a framework for invoking customized pieces of code called application-specific resolvers (ASRs) that encapsulated the knowledge needed for file resolution. Despite this complexity, resolution attempts could fail and require manual repair. This was disclosed in “Flexible and Safe Resolution of File Conflicts”, P. Kumar and M. Satyanarayanan, Proceedings of the USENIX Winter 1995 Technical Conference, January 1995, New Orleans, La., and in “Supporting Application-Specific Resolution in an Optimistically Replicated File System”, Kumar, P., Satyanarayanan, M., Proceedings of the Fourth IEEE Workshop on Workstation Operating Systems, October 1993, Napa, Calif., pp. 66-70.

Thus, there remains a need for a simpler and fail-safe solution to conflict resolution, especially for applications and environments in which users work on a data replica while disconnected from the network and then seek to consolidate their data updates with other replicas of the database. Applications and environments where this is important are increasingly prevalent, with increases in home shopping, home banking and mobile working. It is often unacceptable in these environments to require a user to determine the consistent state that data should be returned to when update conflicts arise.

U.S. Pat. No. 6,088,706 discloses a data management system in which a number of replicas of a shared data file are maintained on different computer systems that are connectable to a mobile communications network. This solution accepts some compromise of data consistency in favour of improved data availability for systems which are usually disconnected from the network. Modifications can be made to each of the replicas and log records of these modifications are maintained. Subsequently, the log records maintained for the replicas are retrieved by connecting to the mobile network. The retrieved log records are merged to generate a sequence of modifications, and rules are applied to that sequence to resolve conflicts before updating the replicas. In U.S. Pat. No. 6,088,706, the conflict resolution is based on priorities assigned to each modification-with the priorities being based on the identities of the users who perform the modifications, or the locations of the replicas. Lower priority modifications may be totally invalidated (preserving file format but losing significant update information) or only partially invalidated (removing the minimum amount of update information but possibly not preserving the file format). U.S. Pat. No. 6,088,706 notes that its automatic conflict resolution cannot produce a logically coherent result in all cases.

U.S. Pat. No. 5,878,434 discloses a method and apparatus for detecting and handling inconsistencies that may occur when transactions performed on disconnected replicas of a database are merged after the computers carrying the replicas are reconnected. A variety of clashes are addressed, including those which arise from inconsistent add, remove, move and modify operations. The clash handling solutions include insertion of an update before or after a clashing update, alteration of the order in which updates occur, consolidation of two updates into one, and creation of a recovery item. Recovery may involve user intervention.

U.S. Pat. No. 5,737,601 and U.S. Pat. No. 5,806,075 disclose replicating modifications made at a local site to multiple remote sites in a peer-to-peer environment. Old and new values from a modification are used to detect conflicts, which modifications are then rolled back and the conflicts addressed by the application program.

Kung, H. T., and Robinson, J. T., “On Optimistic Methods for Concurrency Control” ACM Transactions on Database Systems, Vol.6, No.2, June 1981, pp.213-226 discloses “optimistic” (non-locking) methods of concurrency control which rely on performing updates on a copy of an object and using transaction rollback mechanisms to deal with conflicts. Kung et al notes the disadvantages of conventional solutions to concurrency control based on locks and suggests the suitability of the transaction-oriented optimistic approach for query-dominant systems and for supporting concurrent index operations for large tree-structured indexes.

### SUMMARY OF INVENTION

The present invention provides methods, computer programs and systems for managing replicated data, enabling one or many replicas of a data resource to be updated independently of a master copy of the data resource, and then each replica to be separately consolidated with the master copy. If data updates applied ‘optimistically’ to a local replica conflict with updates applied to the master copy (since the last consolidation with that replica), then the local updates will not be applied to the master copy. Instead, the conflicting local updates are replaced using the current version of the master copy—preferably by backing out the conflicting update transactions and then applying the latest updates from the master copy. If there are no data conflicts when consolidation is performed, then both the master copy and the replica are successfully updated.

In a first aspect, the invention provides a method for managing updates to a replicated data resource, comprising the steps of: applying one or more updates to a first replica of the data resource at a first data processing system; comparing said updates applied to the first replica with a master copy of the data resource held at a second data processing system; for said updates which do not conflict with updates applied to the master copy, applying said non-conflicting updates to the master copy; and for said updates which conflict with updates concurrently applied to the master copy, backing out said conflicting updates from the first replica and replacing them in the first replica with the corresponding updates applied to the master copy.

Preferably, using this approach of optimistic independent updates, individual consolidation with the master copy for each replica, and master-copy-overwrite for avoidance of conflicts, the master copy does not require any subsequent conflict resolution processing (unlike other systems which allow independent updating of replica databases). Conflict resolution at the replica can be a simple matter of overwriting any conflicting data element updates with the corresponding data element updates from the master copy, so there is no need to apply complex programmatic conflict resolution rules at either end.

After a successful consolidation or client backout, further updates can be performed at the local replica, and updates can be performed concurrently at any system maintaining other replicas or the master copy of the data. Hence, a consolidation is not a synchronization of all replicas at once but a merging of updates performed at one replica with the latest version of the master copy of the data resource. Note that “concurrent” updates are not necessarily performed simultaneously just that the updates are performed during a time period when the respective replicas are not fully synchronized with each other.

Preferably, each update performed on any replica of the data resource is handled as a separate transaction with only those replica updates which conflict with the master copy at consolidation time being backed out. Thus, any updates to a data element of a replica will be successfully applied to the master copy except for specific updates which conflict with updates already applied to the master copy, and any updates applied to the master copy since the last consolidation will also be applied to the replica.

A single update transaction may involve updating one or a set of data elements, but it is preferred to limit to a small number of data elements in this set to reduce the likelihood of conflicts and significant backouts. In the context of the present application, a single update transaction encompassing changes to either a single data element or a plurality of data elements will be referred to as a single ‘update’.

In preferred embodiments of the invention, locks are obtained on at least the data elements which have been updated in a local replica-to prevent further updates affecting the integrity of the data, and to simplify backouts. In one preferred embodiment, locks are obtained on updated data elements within a replica database when those elements are updated and the locks are maintained until that replica has been consolidated with the master copy of the data. This means that an application can make only one change to each individual data element before consolidation, avoiding the possibility of a first and second update being performed and then the first update having to be backed out. In an alternative embodiment, in which individual data elements within a replica of a data resource can be incremented or decremented by multiple updates, the locks are only obtained when initiating consolidation between the master copy and the replica to increase concurrency.

Either the update processing at the master copy's server computer is serialized or consolidation-duration locks are also obtained on the master copy, to avoid further updates being performed during a consolidation and to avoid deadlocks. Thus, if attempts are made simultaneously to consolidate multiple replicas with the master copy, only the first of these attempts will proceed. Updates to other replicas will be left locked and uncommitted until this first consolidation is complete (whether all update transactions for this replica are successfully applied and committed, only some are successful, or all fail).

Having initiated consolidation, a determination is made of whether any of the updates applied to the first replica and the master copy are conflicting. Non-conflicting updates are applied to whichever one (or both) of this pair of replicas requires update, whereas conflicting updates to the replica are backed out and overwritten by the updates previously applied to the master copy. When the master has been consolidated with this first replica, consolidation with another replica can proceed.

Preferably, which replica's updates should be consolidated with the master copy is determined by which is first to notify a database manager process running on the master copy's server computer of its desire to consolidate—the consolidation being initiated from the replica's client system. In one preferred embodiment, client systems initiate consolidation in response to the application of local updates. In an alternative embodiment, initiation of consolidation is repeated periodically for each client system. The actual performance of consolidation is preferably managed by the master's server system asynchronously from, but in response to, receipt of a request for consolidation from the client system. This allows the database replication to make use of asynchronous messaging solutions.

Alternatively, if consolidation is initiated by the server system, a ‘round-robin’ consolidation sequence is preferred—possibly with equal consolidation frequency for each of the replicas but this is not essential. These options do not rely on any run-time comparison of inherent priorities of one replica or user over another.

The terms client and server as used herein are merely used for ease of reference. ‘Client system’ refers to any data processing system holding a replica of the data resource and ‘server system’ refers to the system holding the master copy, without implying any essential difference between the hardware or software of those systems. The systems may have a client-server relationship or a peer-to-peer relationship, except that one is holding the master copy of the data resource.

An on-line ordering or reservation solution implementing the present invention differs from conventional on-line reservation systems since each of a plurality of client systems is running a true replica of the data resource, instead of merely submitting queries and update requests to a primary copy of the data resource. The conventional reservation systems require permanent availability of the primary copy, whereas the present invention allows optimistic local updates when it is not possible to access a remote central server or permanent connection is not desirable. According to the present invention, a consolidation without data conflicts will result in the master copy reflecting all updates performed on a replica as well as the replica reflecting all updates applied to the master copy. In conventional, reservation systems, the user of a client system typically first requests from a central system a snapshot of the current state of the data resource (to determine seat availability), then requests performance of updates to the data resource and then waits for confirmation of success, with all updates performed centrally. If the primary copying is currently locked or inaccessible, the clients must wait for write access. Some known systems allow locked data to be read, however, taking the risk of updates failing.

The invention enables a greater degree of autonomy of distributed processes and concurrent local data availability than in a traditional centralized database solution, while avoiding the conflict resolution difficulties which are typical of replicated systems which enable independent updating of the replicas.

The invention's combination of high availability, scalable concurrency and simple conflict resolution can be highly advantageous, especially in a mobile environment in which permanent connectivity to a central system cannot be relied upon. The invention is also particularly advantageous in environments in which a large number of client computers must be able to concurrently update replicated data, and yet data conflicts are expected to be relatively rare.

Note that in some applications, commutative updates to a data element will not be conflicting—such as in the example of on-line shopping where separate customers each order an available item and the store's stock record is reduced (but not reduced to zero) or an order list is incremented in response to each of them—the sequence of updates does not matter until stock levels are very low. In an example airline reservation application, two different travel agents concurrently attempting to reserve the last seat in an aircraft will result in a conflict and one will be rejected, but many travel agents can process bookings concurrently when the aircraft still has several unreserved seats and the rejection will typically be notified to the relevant agent at least as quickly as in a centralised database solution.

In further aspects, the invention provides each of a client data processing system, a server data processing system and a distributed data processing system, wherein the distributed system comprises: a first data processing unit having access to a master copy of a data resource; a plurality of additional data processing units which each have access to a local replica of the data resource for performing updates to their respective local replicas; and means for consolidating any updates applied to the master copy and any updates applied to one or more replicas of the data resource according to a method as described above.

The consolidation of updates according to the invention may be implemented by a computer program product, comprising program code recorded on a machine-readable recording medium for controlling the operation of a data processing system on which the code runs to perform a method as described above.

### BRIEF DESCRIPTION OF DRAWINGS

Preferred embodiments of the invention will now be described in more detail, by way of example, with reference to the accompanying drawings in which:

FIG. 1 is a schematic representation of a network in which the present invention may be implemented;

FIG. 2 is an example user view of seat availability within an aircraft within an airline reservation system implementing the present invention;

FIG. 3 is an example user view according to FIG. 2 after consolidation between replica 120 and master copy 100 of a database reflecting seat reservations;

FIG. 4 is an example user view according to FIG. 2 after consolidation between replica 110 and master copy 100; and

FIG. 5 is a schematic flow diagram showing the sequence of steps of a method implementing the present invention.

### DETAILED DESCRIPTION OF PREFERRED EMBODIMENTS

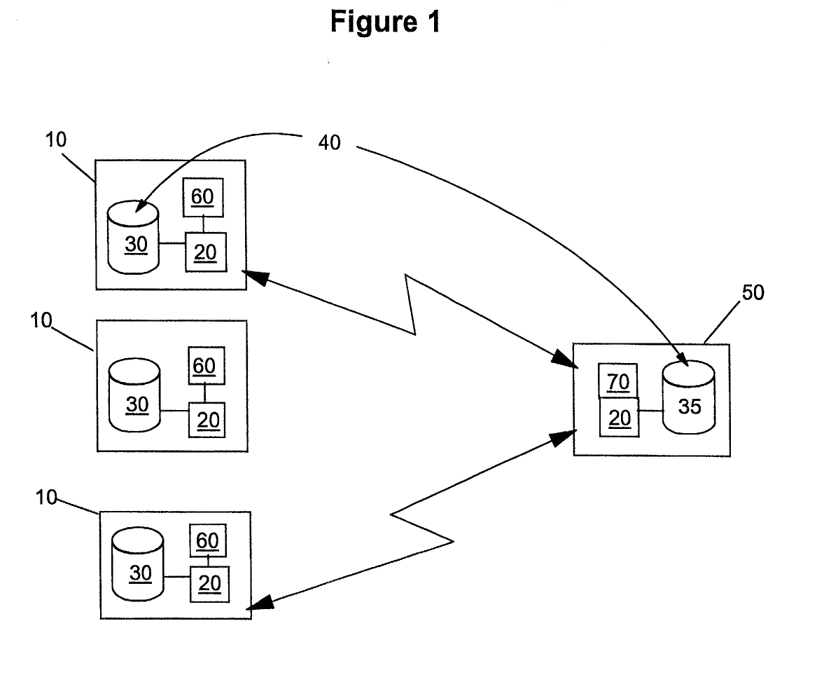

As shown in FIG. 1, a plurality of client data processing systems 10 are each running an application program 60 and a database manager program 20 and each hold a replica 30 of a database 40. Each client system 10 is connectable to a server data processing system 50 which is also running a database manager program 20 and holds a master copy 35 of the database 40. The present invention is applicable to any network of data processing systems in which the client systems are capable of running the database manager program to maintain their local replica of the database, but is particularly suited to applications in which a number of replicas are updated on mobile devices or desktop workstations before being consolidated with the master copy held on a back-end server computer. The invention is especially useful in environments in which either a large number of client systems may need to concurrently apply local updates to the database, or a number of the client systems rely on wireless communications to connect to the server computer and so cannot rely on permanent availability of connections.

An implementation of the present invention will now be described using the illustrative example of an airline reservation application in which users (such as travel agents and airline employees) working at a number of client workstations each need to be able to process their customers' requests to book seats on an airline.

The reservation application 60 sees each table of the local replica database as if it is the only copy, and as if only that application is accessing it. For illustration, the table could be a simple hash table of data and an index. Hidden from the application's view within a consolidation process 70 of the database manager 20 is some more state information.

For each element in the table, the following information is held and sent as part of an update consolidation request (as will be described further below):

| | |
|---|---|
| protected Object underlyingObject; | // The application object being contained. |
| protected Object oldUnderlyingObject; | // The before image, in case we back out. |
| protected Object key; | // If The object identifier key. |
| protected long unitOfWorkIdentifier = 0; | // Unit of work for an update. |
| protected long tableSequenceNumber = 0; | // Server/Master sequence number of last table update |
| | // we received. |
| protected long sequenceNumber = 0; | // Sequence number of last object update we made, |
| | // incremented by 1. |
| int state; | // The current state of the managedObject. |
| // The lifecycle of the object. | |
| static final int stateError = 0; | // A state error has occurred. |
| static final int stateConstructed = 1; | // Not yet part of a transaction. |
| static final int stateAdded = 2; | // Added. |
| static final int stateReplaced = 3; | // Replaced. |
| static final int stateDeleted = 4; | // Deleted. |

The use of the “before” image, sequence numbers and consolidation processing will be described later.

For the table as a whole, the following information is also held and sent in update consolidation requests:

// The highest tableSequenceNumber in the entire table.

// This may be higher than any recorded in our version of the table

// because our update may have been the latest; it also allows the

// master to detect that this is a repeat update.

protected long highestTableSequenceNumber=0;

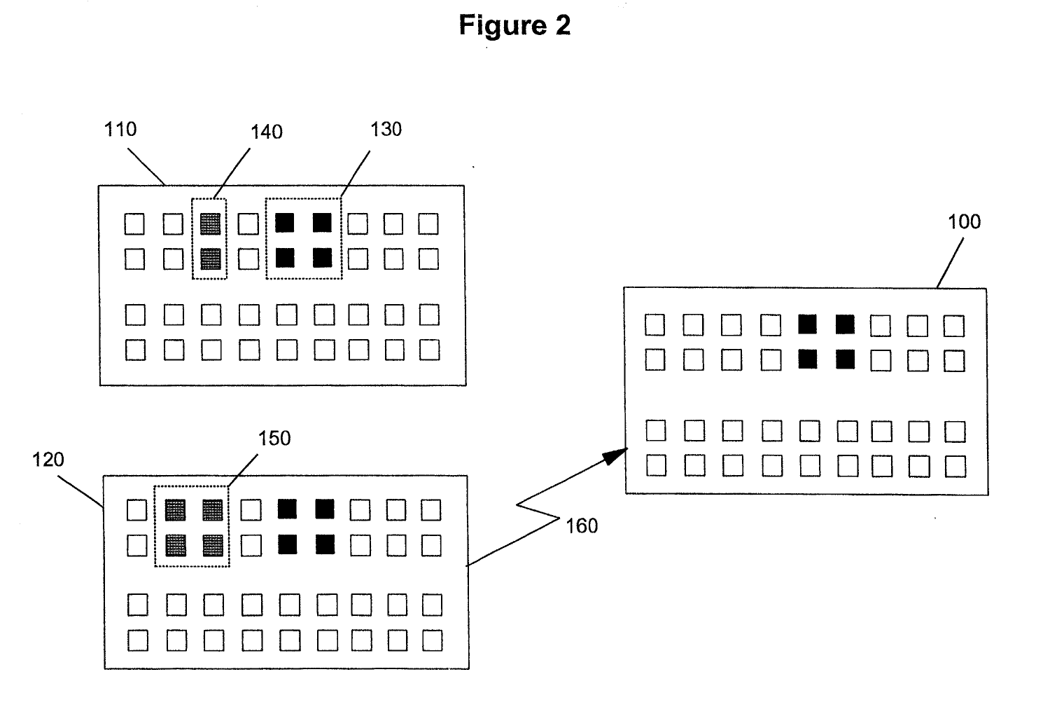

The user's view of seat availability for the airline is as shown in FIG. 2, with each specific seat being a separately identifiable data element of the database and being separately reservable. FIG. 2 shows three views of the data resource—the master copy 100 as updated at the server, a first replica 110 and a second replica 120.

A first set of data elements 130 corresponding to seats in an aircraft have been updated and the replicas 110, 120 of the data resource have each been consolidated with the master copy 100 so that the reservation is now reflected in each of the replicas. Subsequent to that consolidation, further updates are made concurrently to replica 110 and replica 120. A first update 140 to local replica 110 indicates a desire to reserve two seats. A lock on the relevant local database entry is obtained to avoid another conflicting attempt at the same client system to reserve the same seat, and because this update has not yet been successfully consolidated with the master copy of the database and may have to be backed out. The update is in-doubt (uncommitted) while the lock is maintained.

An update 150 of replica 120 indicates a desire to reserve four seats, but the user of the client system of replica 110 has concurrently attempted to reserve two of these four seats. Local replica 120 is optimistically updated concurrently with replica 110 and the updated data elements within replica 120 are locked to prevent ‘internal conflicts’ (multiple conflicting updates of the local replica) and to indicate that the updates are in doubt. Which of these replicas 110, 120 has its local updates successfully applied to the master copy 100 of the database depends on which client system is first to notify the server system of its desire for consolidation.

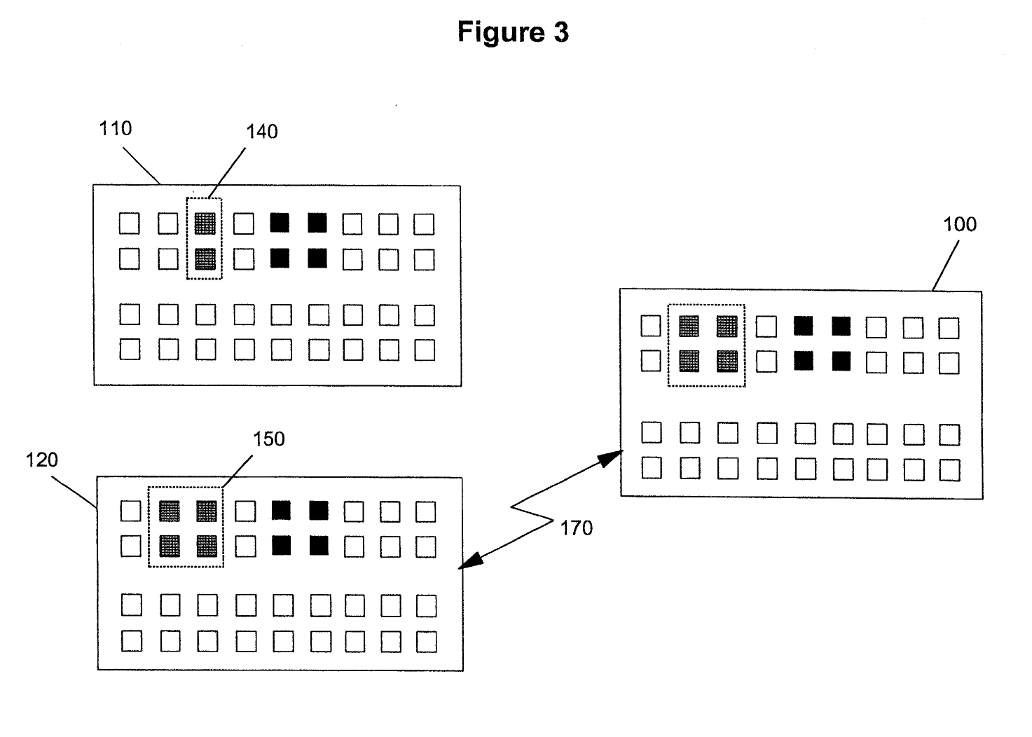

Let us assume that the client system maintaining replica 120 is the first to request consolidation 160. Since there is no consolidation processing currently in progress and there is no conflict between updates applied to the master copy and updates applied to replica 120 since their last consolidation, the updates will be successfully applied 170 to bring the replica 120 and the master copy 100 into a consistent state, as shown in FIG. 3. Note that replica 110 still has local updates which have not been consolidated with other replicas, and which are now inconsistent with the master copy of the data. After consolidation between the master copy and replica 120, further updates may be applied to the replica 120 or the master copy 100, and further updates may also be optimistically applied to replica 110.

The client system maintaining replica 110 now attempts to consolidate with the master copy 100 of the data. The updates that have been applied to the replica 110 since it was last consolidated with the master copy 100 now conflict with the recent updates to the master copy, and so they cannot now be applied. Instead, the server-side update transaction which is attempting to apply the local replica's conflicting updates to the master copy is backed out, and the local client transaction which applied conflicting updates to replica 110 is also backed out. The updating application running at the client system is notified, either by a return value to a synchronous consolidation request or, in the preferred embodiment, by an asynchronous callback to an asynchronous consolidation request. The local update is backed out by reinstating (temporarily) the “before update” image of the data.

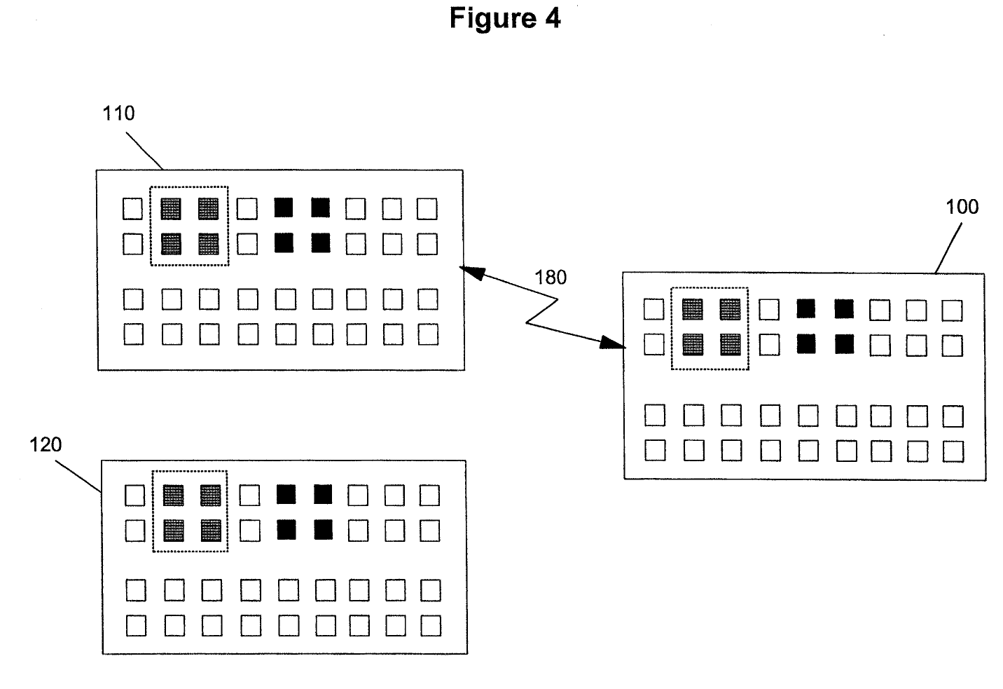

Then this “before update” image is overwritten with the latest updates to the master copy 100. The result of this is shown in FIG. 4. In this example, all copies of the data are now consistent, with conflicting client updates not having been allowed to change the master copy. This has been achieved without complex programmatic conflict resolution processing at any of the systems in the network.

Thus each travel agent and the airline has a copy of the seat reservations, and two or more agents may ‘optimistically’ update their own view of the data to attempt to reserve the same seat. Initially, these updates are not committed. On subsequent consolidation, one agent sees a successful consolidation with their updates committed, whereas the others see a failure due to the first agent now holding the seat. Neither agent needs a connection to the airline's copy of the database table in order to request the reservation, but the reservation will only be processed locally until the update is consolidated with the airline's copy.

It should be noted that the present invention does not require synchronization of all replicas at any one time (although this could be implemented using conventional techniques if global syncpoints are required for other reasons), and does not require the master copy to immediately reflect the very latest updates performed at client systems.

Instead, the invention allows each replica to be updated independently of each other and independently of the master copy, but for the update transactions to be held in doubt until they are subsequently consolidated with the latest version of the master copy of the data. Sufficient information is held for backing out conflicting updates (sequence number and the local replica's incremental changes—see above), preferably without reliance on database logs. Any non-conflicting updates are applied to the respective one of the local replica or master copy of the database, and any conflicting updates result in a back-out at the client. This backout is achieved by reinstating the image of the relevant database elements and then overwriting the relevant database elements at the client using the corresponding data from the server.

By handling each update as a separate transaction, only a small number of local replica updates have to be backed out in most cases, although it is preferred that all updates entered between consolidation points will be identifiable as a set in case they are deemed interdependent by the user or updating application program. In one embodiment of the invention, a set of updates to data elements (such as booking seats in an aircraft for a group) can be applied together as a single transaction or explicitly flagged as an interdependent set of transactions, so that if one update cannot be applied to the server's master copy of the data then they will be backed out as a set at the client.

A degree of short term inconsistency between replicas of the data resource has been accepted to achieve improved concurrency and availability of data, with optimistic updating of local replicas of the data and a very simple backout processing. All updates are eventually applied to all replicas of the data unless they conflicted with updates applied to the master copy, and problematic data conflicts are avoided by the decision to accept the master copy's validity in the case of conflicts.

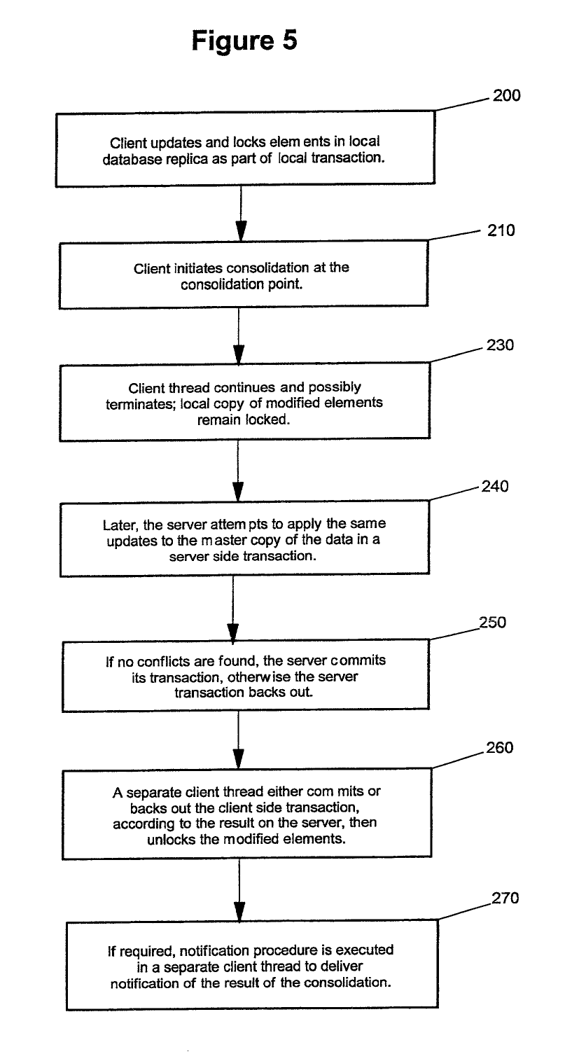

A specific implementation will now be described in more detail with reference to FIG. 5. As described above, updates can be applied 200 to a local replica of a database without requiring continuous access to the master copy of the database held on a server, without requiring all replicas to be concurrently locked for synchronization, and without complex programmatic conflict resolution processing.

When updates are applied locally 200, the database manager program 20 updates the relevant rows and columns of the database 40 as one or more local transactions in response to user input via the local application program 60. Locks are obtained on the updated data elements of the local replica by the local database manager 20 locking the relevant row of the relevant database table, and these locks are maintained until resolution of consolidation processing—even if the client processing thread terminates.

Subsequently, when a local update transaction completes, the updates performed on the local copy and any updates performed on the master copy of the database held at the server are consolidated. This involves the local database manager program 20 sending 210 an asynchronous request message to the server system 50 holding the master copy 35 of the database. The database manager program 20 running on the server 50 receives these requests and places them in a FIFO queue 220 for serialization.

The request includes:

a unique unit of work identifier for the request;

the highest sequence number in the table (in order to determine which updates the replica has not yet applied); and, for each changed data element,

the new state of each changed data element (i.e. added, deleted, replaced);

the new data (if any); and

the sequence number for the version of the master copy on which the update is based.

When ready to process a next consolidation request, a consolidation manager process 70 within the database manager 20 of server computer 50 processes 240 this information within the request to identify which rows of the database tables have been updated since the last consolidation with this replica. This is managed by comparing a replica database table row's sequence number with the sequence number of the corresponding row in the master copy.

The sequence number is incremented in the master copy of the database whenever the respective row of the master copy's database is updated, and this sequence number is copied to the corresponding row in a replica when that replica is consolidated with the master copy. Hence, the database table rows of the master copy always retain a sequence number which can be checked against a the database rows of a local replica to determine a match. If they match, then that row of the master copy of the database has not been updated since it was consolidated with this local replica, and so any updates applied to that row of the local replica can be safely applied to the master copy at consolidation time. In that case, a set of one or more server side transactions applies to the master copy the updates defined in the request message and the transactions are committed 250.

If they do not match, then that row has been updated in the master copy, and in that case the server side update transaction is backed out 250. This is notified to the client side and the in-doubt client-side transaction which applied the conflicting update is also backed out 260. Next, the updates which had been applied to the master copy before consolidation (including those which led to the mismatch) are applied to the local replica. The local locks held on the replica's database rows are then released 260.

Hence, if the database rows updated in the local copy are different from the rows updated in the server-based master copy, all updates are successful and locks are released. Whereas, if conflicts are identified when consolidation is attempted, all conflicting local updates since the last consolidation point are backed out and the relevant database table rows of the local replica are overwritten using the updates applied to the corresponding rows of the master copy of the database.

The invention avoids complicated programmatic conflict resolution processing, since the decision has been made to always rely on the master copy when any conflicts arise, to handle each client replica's consolidation separately from other replicas and to use FIFO ordering of client consolidation requests rather than comparing priorities or massaging update sequences in response to identifying conflicts.

The local system is sent sufficient update information by the server to make the local replica consistent with the current version of the master copy, avoiding the need for complex programmatic transactional backout processing for those updates of the local replica which result in conflicts.

By avoiding strict adherence to a time sequence of updates performed across the plurality of replica databases, accepting the overwriting of optimistic client updates by the master copy whenever a conflict is identified, the invention greatly simplifies conflict resolution compared with typical prior art solutions and thereby ensures that manual resolution of conflicts is never needed.

In the preferred implementation of the invention, a notification is sent to the local system of which data element of a local update resulted in a conflict with the server copy (e.g. which specific row of the database had conflicting updates). This way, where a local update transaction involved updating a number of data elements, the application is given sufficient information to retry, or invite the user to retry, updating of all data elements except for the data element (or database row) which conflicted. Nevertheless, the potential conflicts between transactional updates can themselves be resolved without user involvement.

This is different from conventional solutions which always require database updates to be performed on the primary copy and then replicated to secondary read-only copies. In particular, this invention does not require continuous access to the primary copy and is more scalable since it enables concurrent updates to multiple local replicas which will each be successfully consolidated with the server unless a conflict arises between the updates applied to the server copy and updates applied to one of the local replicas. When this problem arises, the server copy overwrites the conflicting local copy and the user of the local system starts again (possibly retrying updates of specific data elements other than the one which resulted in a conflict, if this makes sense for the particular application).

Note that when comparing the master copy with a replica, the updates which have been applied to the master may have been initiated at a different local replica since each replica is able to perform local updates and to consolidate with the server independently of the others.

The invention avoids potentially-unresolvable conflicts without complicated conflict resolution programming, which would be a problem if trying to build an asynchronous database-update solution which relies on low-level messaging. Hence, the most useful applications of this invention are probably for pervasive devices for which permanent access to server cannot be relied on and for which reliance on low-level messaging is essential.

The following sequence of operations is preferred:

1) Client updates 200 and locks elements in the local database replica as part of an encompassing local transaction.

2) Client initiates consolidation 210 at the consolidation point.

3) The client thread continues and possibly terminates 230, the local copy of the modified elements remain locked.

4) Later, the server attempts 240 to apply the same updates to the primary copy of the data in a server side transaction.

5) If no conflicts are found, the server commits 250 its transaction, otherwise the server transaction backs out 250.

6) A separate client thread either commits 260 or backs out 260 the client side transaction, according to the result on the server, then unlocking the modified elements.

7) If required, notification procedure is executed 270 in a separate client thread to deliver notification of the result of the consolidation.

The programming construct implemented by the present invention may be called a “Consolidation Point”—a place in the logic of a program where updates to a copy of a resource are to be merged with another copy. Although the preferred embodiment described above includes synchronous processing for the database merge operation, this could be completed asynchronously in alternative implementations.

The resource in question could be a database table, or a queue, or generally any data where a copy is held locally for update. Elements in the resource are locked (preferably when they are updated) and unlocked when the merge completes. The result of the merge is reported back to the program as success or failure of the merge. If the merge succeeds, the updated values persist in both copies of the resource and are unlocked in the local copy. If the merge fails, perhaps due to some conflicting update in the merge processing, then the local copy of the resource elements are updated to be the same as the remote server copy and the elements unlocked. Thus, in the event of the merge processing failing because there are conflicting updates, the resource elements will be returned to a known consistent state.

The invention applies to situations in which there are two copies of a table, or many copies.

The “Consolidation Points” define a section of program logic where either all of the changes to elements in the local copy within the scope of a single transaction are merged, or none of them are merged. After the consolidation processing has completed the changed elements are unlocked so that further changes may be applied to any of the copies, and either none of the changes persist or all of them persist.

This programming construct is similar in concept to a “Synchronisation Point” in distributed transaction processing, however instead of fixing a place in the logic of the program where updates to resource managers commit or back out, this fixes a place in the logic of the program where a set of updates to a table are merged with another copy of the table, the merge either succeeds or fails. A “Consolidation Point” and the Synchronisation Point” could be one and the same place in the program logic.

In preferred implementations, the state of the tables is well defined and easy to program to. It is either the state before or after all of the updates are applied, and if the merge of the two resources fails then the updates that were not applied are also well defined. Furthermore the updates to the replica can be coordinated with transactional resources by executing the prepare phase of a two phase commit where the entity performing the consolidation is also of the two phase commit coordinator.

In many conventional solutions, a replication error is reported in an error log. This has three significant disadvantages: it is not easily accessible to the program logic; the precise scope of the failure is not defined, in fact in most cases some of the updates are applied; and the updates cannot easily be coordinated with other updates.

Additional embodiments and variations of the embodiments described herein in detail will be clear to persons skilled in the art, without departing from the described inventive concepts. For example, the embodiments described above include submitting a request for consolidation which request includes all of the required information for identifying data conflicts, whereas alternative embodiments may include an asynchronous request for consolidation followed by the server establishing a synchronous communication channel with the client system for exchanging information and identifying conflicts.

In another implementation, some applications may require an automatic retry of one or more of the data element updates that are within a failed encompassing update transaction. If the application or the local replica's database manager program is notified of which data element update resulted in a conflict with the master copy, it will be possible to retry all or a subset of the other data element updates. This may be done as a set of separate transactions or as a single transaction which encompasses all of the failed transaction's data element updates except the one which caused the failure.

What is claimed is:

1. A method for managing updates to a replicated data resource, comprising the steps of:
applying one or more updates to a first replica of the data resource at a first data processing system;
comparing said updates applied to the first replica with a master copy of the data resource held at a second data processing system;
for said updates which do not conflict with updates applied to the master copy, applying said non-conflicting updates to the master copy; and
for said updates which conflict with updates concurrently applied to the master copy, backing out said conflicting updates from the first replica and replacing them in the first replica with the corresponding updates applied to the master copy.

2. A method according to claim 1, wherein:
said step of applying one or more updates to the first replica comprises performing said updates as one or more transactions at the first data processing system and locking updated data elements of the first replica;
a process at said second data processing system initiates one or more update transactions at the second data processing system to apply said one or more updates to the master copy of the data resource; and
the step of applying said non-conflicting updates comprises committing the respective transactions at the second data processing system and at the first data processing system and unlocking the updated data elements; whereas
the step of backing out said conflicting updates from the first replica and replacing them is implemented by backing out the respective transactions at both the second data processing system and at the first data processing system, unlocking the updated data elements at the first replica, and applying the conflicting updates of the master copy to the corresponding data elements of the first replica.

3. A method according to claim 2, wherein:
in response to updates applied concurrently to a plurality of replicas of the data resource, the application of the replicas' updates to the master copy of the data resource is serialized such that only one replica of the data resource will be consolidated with the master copy at any one time.

4. A method according to claim 3, wherein:
the plurality of replicas are held at a plurality of data processing systems, and each of said plurality of systems sends to the second data processing system requests to apply their updates to the master copy; and
said process at the second data processing system serializes received requests to apply updates, to ensure that only one replica of the data resource will be consolidated with the master copy at any one time.

5. A method according to claim 4, wherein a request is sent to the second data processing system in response to completion of one or more transactions at a respective one of the plurality of data processing systems.

6. A method according to claim 4, wherein said requests to apply updates are sent via asynchronous messaging.

7. A method according to claim 4, wherein said requests contain a description of the one or more updates applied to the respective replica.

8. A method according to claim 7, wherein said requests also include an incremented version identifier for the updated data elements, for comparison with a current version identifier for the corresponding data elements of the master copy.

9. A method according to claim 7, wherein said description includes an identification of the version of the master copy which was last consolidated with the respective replica, for comparison with a current version identifier of the master copy.

10. A method according to claim 1, wherein the updates comprise orders for goods or services.

11. A method according to claim 1, wherein comparing said updates applied to the first replica with a master copy of the data resource comprises comparing version identifiers for data elements of the data resource, the version identifiers being incremented when updates are applied.

12. A method for managing updates to a replicated data resource, comprising the steps of:
in response to one or more updates applied to a first replica of the data resource at a first data processing system, comparing said updates with a master copy of the data resource held at a second data processing system;
for said updates which do not conflict with the master copy, applying said non-conflicting updates to the master copy; and
for said updates which conflict with the master copy due to other updates applied to the master copy, sending to the first data processing system an instruction to back out said conflicting updates from the first replica and to replace them in the first replica with the corresponding other updates applied to the master copy.

13. A method for managing updates to a replicated data resource, comprising the steps of:
applying one or more updates to a first replica of the data resource at a first data processing system;
sending a request, to a second data processing system which holds a master copy of said data resource, for applying the one or more updates to the master copy;
for said updates which do not conflict with the master copy and are successfully applied to the master copy, responding to a confirmation of the successful application of updates to the master copy by committing the updates to the first replica at the first data processing system; and
for said updates which conflict with the master copy due to other updates applied to the master copy, such that said conflicting updates are not applied to the master copy, responding to a confirmation of failure from the second data processing system by backing out said conflicting updates from the first replica and replacing them in the first replica with the corresponding other updates applied to the master copy.

14. A method according to claim 13, wherein the first data processing system is a wireless communications device and communicates with the second data processing system via low level messaging.

15. A database manager for managing updates to a replicated data resource, the database manager including:
means, responsive to an identification of one or more updates applied to a first replica of the data resource at a first data processing system, for comparing said updates with a master copy of the data resource held at a second data processing system;
means for applying to the master copy said updates which do not conflict with the master copy;
means for sending to the first data processing system an instruction to back out from the first replica said updates which conflict with the master copy, due to other updates applied to the master copy, and to replace them in the first replica with the corresponding updates applied to the master copy.

16. A database manager for running at a first data processing system for use in a method for managing updates to a replicated data resource, the database manager including:
means for applying one or more updates to a first replica of the data resource at the first data processing system;
means for sending a request, to a second data processing system which holds a master copy of said data resource, for applying the one or more updates to the master copy;
means for responding to a confirmation of the successful application of updates to the master copy, for said updates which do not conflict with the master copy, by committing the updates to the first replica at the first data processing system; and
means for responding to a confirmation of failure to apply updates to the master copy, for said updates which conflict with the master copy due to other updates applied to the master copy, by backing out said conflicting updates from the first replica and replacing them in the first replica with the corresponding other updates applied to the master copy.

17. A data processing system comprising:
a processor;
a storage means for storing a master copy of a data resource;
means, responsive to an identification of one or more updates applied to a first replica of the data resource at a first data processing system, for comparing said updates with the master copy of the data resource;
means for applying to the master copy said updates which do not conflict with the master copy;
means for sending to the first data processing system an instruction to back out from the first replica said updates which conflict with the master copy, due to other updates applied to the master copy, and to replace them in the first replica with the corresponding other updates applied to the master copy.

18. A data processing system comprising:
a processor;
a storage means for storing a first replica of a data resource;
means for applying one or more updates to the first replica of the data resource;
means for sending a request, to a second data processing system which holds a master copy of said data resource, for applying said one or more updates to the master copy;
means for responding to a confirmation of the successful application of updates to the master copy, for said updates which do not conflict with the master copy, by committing the updates to the first replica; and
means for responding to a confirmation of failure to apply updates to the master copy, for said updates which conflict with the master copy due to other updates applied to the master copy, by backing out said conflicting updates from the first replica and replacing them in the first replica with the corresponding other updates applied to the master copy.

19. A program product comprising machine-readable program code recorded on a recording medium, the program code comprising instructions for controlling the operation of a current data processing system on which it executes to perform the following steps:
in response to one or more updates applied to a first replica of the data resource at a first data processing system, comparing said updates with a master copy of the data resource held at the current data processing system;
for said updates which do not conflict with the master copy, applying said non-conflicting updates to the master copy; and
for said updates which conflict with the master copy due to other updates applied to the master copy, sending to the first data processing system an instruction to back out said conflicting updates from the first replica and to replace them in the first replica with the corresponding other updates applied to the master copy.

20. A program product comprising machine-readable program code recorded on a recording medium, the program code comprising instructions for controlling the operation of a first data processing system on which it executes to perform the following steps:
applying one or more updates to a first replica of the data resource at the first data processing system;
sending a request, to a second data processing system which holds a master copy of said data resource, for applying the one or more updates to the master copy;
for said updates which do not conflict with the master copy and are successfully applied to the master copy, responding to a confirmation of the successful application of updates to the master copy by committing the updates to the first replica at the first data processing system; and
for said updates which conflict with the master copy due to other updates applied to the master copy, such that said conflicting updates are not applied to the master copy, responding to a confirmation of failure from the second data processing system by backing out said conflicting updates from the first replica and replacing them in the first replica with the corresponding other updates applied to the master copy.
